(19) United States
(12) Patent Application Publication
(10) Pub. No.: US 2014/0149067 A1
(43) Pub. Date: May 29, 2014

(54) IMPACT AND ACCELERATION DETECTION

(71) Applicant: Brain Sentry LLC, (US)

(72) Inventors: Gregory L. Merril, Bethesda, MD (US); Robert F. Cohen, Kensington, MD (US); Scott McDermott, Washington, DC (US); Anthony Valenzano, Archbald, PA (US); J. Michael Brown, Sunnyvale, CA (US)

(73) Assignee: Brain Sentry LLC, Bethesda, MD (US)

(21) Appl. No.: 13/863,026

(22) Filed: Apr. 15, 2013

Related U.S. Application Data
(60) Provisional application No. 61/623,713, filed on Apr. 13, 2012.
(60) Provisional application No. 61/705,329, filed on Sep. 25, 2012.

(51) Int. Cl. G01P 15/09

(52) U.S. Cl. CPC G01P 15/09
USPC 702/141

(57) ABSTRACT

An sensor system measures acceleration and detects impacts. According one embodiment of the present invention, an impact sensor system attaches to a helmet, detects impacts, and displays indications of single and cumulative impacts. Identifying impacts when they occur can help identify players to be screened for concussion or taken out of action before they show symptoms. This can help prevent concussions that result from cumulative hits, which are often more dangerous than those that result from a single hit. The system serves as a continue-to-play decision support aid.

### CROSS-REFERENCE TO RELATED APPLICATIONS

This application claims priority from U.S. Provisional Patent Application Ser. No. 61/623,713, titled “System and Method for Impact Detection” and filed Apr. 13, 2012, and from U.S. Provisional Patent Application Ser. No. 61/705,329, titled “Vibration Sensor and Method for Detecting Acceleration” and filed Sep. 25, 2012, the disclosures of which are incorporated herein by reference in their entireties.

### BACKGROUND

1. Technical Field

Present invention embodiments relate to acceleration and impact measurement. One use is for detecting impacts to a person's headgear.

2. Discussion of the Related Art

In many sports, athletes sustain brain injuries despite the use of protective headgear (e.g., helmets). These brain injuries are not always readily apparent or detectable when they first occur. As a result, athletes sometimes continue to play, unaware that they are at risk for further injury with potentially debilitating consequences. Among the thirty-eight million boys and girls who participate in organized youth sports in the United States, mild traumatic brain injury (mTBI, also referred to as a “concussion”) is among the most common reported injuries. On average, approximately 1.7 million people sustain a traumatic brain injury (TBI) annually. Direct medical costs and indirect costs (e.g., lost productivity) of TBI totaled an estimated $60 billion in the United States in 2000. The number of people with TBI who are not seen in an emergency department or who receive no care is unknown. that could cause a mild traumatic brain injury (mTBI, also referred to as a “concussion”).

### BRIEF SUMMARY

According to one embodiment of the present invention, a system for measuring acceleration comprises a piezo sensor to produce a signal including a decaying sinusoid in response to an impact and a processor configured to receive data of the signal and process the data to determine a magnitude of the impact.

According to another embodiment of the present invention, a system for detecting impacts comprises a housing containing an acceleration sensor for detecting impacts to the housing and providing a signal representative of applied impacts. A shock absorber couples the housing and the acceleration sensor such that the acceleration sensor experiences a lower peak acceleration than the housing as a result of a detected impact to the housing. A processor is configured to receive data from the acceleration sensor and determine whether a magnitude of an impact exceeds a threshold.

According to yet another embodiment of the present invention, an impact sensor system attaches to a helmet, detects impacts, and displays indications of single and cumulative impacts. Identifying impacts when they occur can help identify players to be screened for concussion or taken out of action before they show symptoms. This can help prevent concussions that result from cumulative hits, which are often more dangerous than those that result from a single hit. The system serves as a continue-to-play decision support aid.

### BRIEF DESCRIPTION OF THE SEVERAL VIEWS OF THE DRAWINGS

Generally, like reference numerals in the various figures designate like components.

FIG. 1A is a view in perspective of a football helmet bearing an impact detection system of the present invention.

FIG. 1B is a bottom view in plain of the impact detection system of FIG. 1A.

FIG. 1C is a side view in plain in of the impact detection system of FIG. 1A.

FIG. 1D is a top view in plain of the impact detection system of FIG. 1A.

FIG. 1E is side view in section of the impact detection system of FIG. 1A.

FIG. 2A is a view in elevation of a shock absorption system configured with force absorbing material as a cushion between a circuit board and an enclosure according to an embodiment of the present invention.

FIG. 2B is a view in elevation of a shock absorption system configured with an elastic material as a suspension system between a circuit board and an enclosure according to an embodiment of the present invention.

FIG. 2C is a view in elevation of a shock absorption system configured with springs as a suspension system between a circuit board and an enclosure according to an embodiment of the present invention.

FIG. 2D is a view in elevation of a shock absorption system configured with a force absorbing material in conjunction with a spring suspension system according to an embodiment of the present invention.

FIG. 2E is a view in elevation of a shock absorption system configured with one or more sensors mechanically isolated from a circuit board and from an enclosure by absorbing material according to an embodiment of the present invention.

FIG. 3 is a schematic illustration of circuit components of an impact detection system according to embodiments of the present invention.

FIG. 4 is a diagrammatic illustration of a manner of performing configuration of the impact detection system at startup according to an embodiment of the present invention.

FIG. 5 is a procedural flow chart illustrating a manner of handling a timer interrupt according to an embodiment of the present invention.

FIG. 6 is a procedural flow chart illustrating a manner of handling an acceleration event according to an embodiment of the present invention.

FIG. 7 is a procedural flow chart illustrating a manner of handling a user action according to an embodiment of the present invention.

FIG. 8 is a schematic illustration of an impact detection system using a cantilevered piezo type sensor according to an embodiment of the present invention.

FIG. 9 is a graphical representation of an example decaying sinusoid produced by a cantilevered piezo type sensor of a present invention embodiment.

### DETAILED DESCRIPTION

According to one embodiment of the present invention, an impact detection system attaches to a player's helmet and detects impacts that could cause a concussion. The system includes one or more sensors (e.g., micro-electromechanical system (MEMS) sensors or other sensors to measure linear acceleration, rotation, temperature, etc.) and a display to indicate impacts. The sensors can be calibrated to match various types of helmets, the size and age of the wearer, and particular sports or activities. Small volume and low weight make the device unobtrusive to the wearer.

One aspect of an embodiment of the present invention is a force propagation attenuator (FPA) system, which allows acceleration sensors (e.g., MEMS sensors such as those used in smart phones and game controllers) to be used to measure forces beyond their native ranges. The FPA system can be implemented using hardware, software, or both. In a hardware implementation, material (e.g., foam rubber, polyurethane, etc.) is arranged to absorb a portion of the energy transferred to the sensor enclosure from an impact on the helmet to which it is attached. The arrangement of material is sometimes referred to as a shock absorption system. In a software implementation, when the sensor is saturated with a force that exceeds its native range, a processor performs a predictive analysis of the sensor data to calculate the peak force experienced by the sensor.

Another aspect of an embodiment of the present invention is an impact and acceleration detector that reconstructs an initial acceleration based on the oscillatory response of a cantilever type piezo sensing element.

Yet another aspect of an embodiment of the present invention is to present indications of impacts according to a plurality of impact thresholds. For example, the impact detection system can be calibrated to signal a YELLOW alert at a pre-set probability of injury (e.g., 25%) for rotational and/or linear acceleration, and to signal a RED alert at a second risk level (e.g., 50% probability of injury). Any number of alert signals or displays can be implemented.

An example standard on which to base the thresholds for linear acceleration is the Head Injury Criterion (HIC) scale, given by

$$H I C = {\{ {[ \frac{1}{{t}_{2} - {t}_{1}} {\int }_{{t}_{1}}^{{t}_{2}} a ( t ) d t ]}^{2.5} ( {t}_{2} - {t}_{1} ) \}}_{max}$$

where t₁ and t₂ are the initial and final times (in seconds) of the interval during which HIC attains a maximum value, and acceleration a is measured in units of g (standard gravity acceleration). The maximum time duration of HIC, t2−t1, is limited to 15 milliseconds.

HIC includes the effects of head acceleration and the duration of the acceleration. At a HIC of 1000, one in six people will suffer a life-threatening injury to their brain (more accurately, an 18% probability of a severe head injury, a 55% probability of a serious injury and a 90% probability of a moderate head injury to the average adult). HIC is used to determine the U.S. National Highway Traffic Safety Administration (NHTSA) star rating for automobile safety and to determine ratings given by the Insurance Institute for Highway Safety. Sport physiologists and biomechanics experts use the HIC in the research of safety equipment and guidelines for competitive sport and recreation. In one study, concussions were found to occur at HIC=250 in most athletes. Studies have been conducted in skiing and other sports to test adequacy of helmets.

Another aspect of an embodiment of the present invention is dynamic sensitivity. The software of the system can be programmed to lower the warning threshold(s) after each successive impact event, since each successive significant head impact is more likely to cause a brain injury. For example, one hit might require 100 g to trigger a RED signal; a second hit at 90 g in the same week would trigger a RED signal; and a third hit in the same week would only need to be at 80 g to trigger a RED signal. Similarly, the system could be set to display a YELLOW warning at an initial threshold of 60 g for the first impact; a second impact warning would be triggered at a lower threshold (e.g., 50 g); and a third, and any subsequent, impacts would push the threshold still lower.

After an impact exceeding a threshold is detected, the threshold(s) can be further adjusted over time to model healing in the brain. For example, if a 50 g impact triggers a YELLOW alert, the software of the system will start a countdown timer, and after a calculated period of time (typically in the 10 day to 45 day range) the indication of that impact will be turned off (“extinguished”). The calculation may be based on factors including magnitude of impact, direction of impact (top, side or front), whether there are other impacts that have been detected and yet to be extinguished, medical history of wearer, etc.

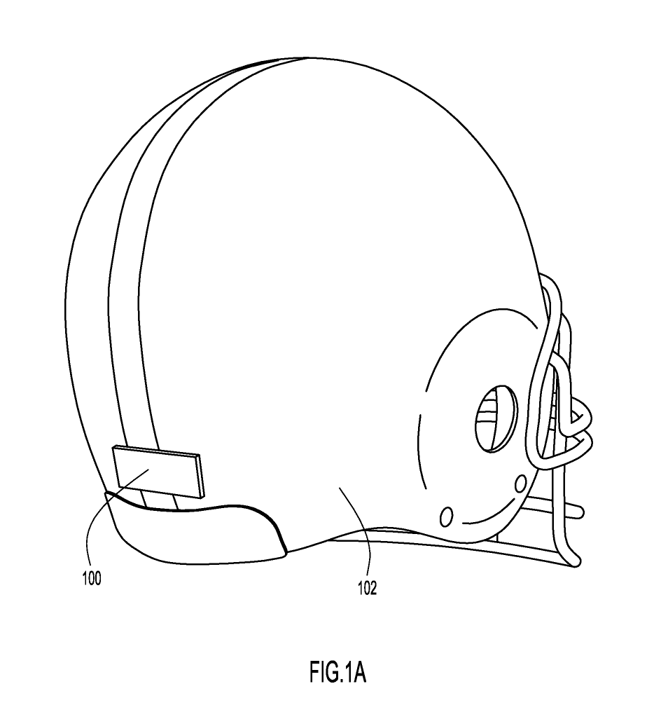

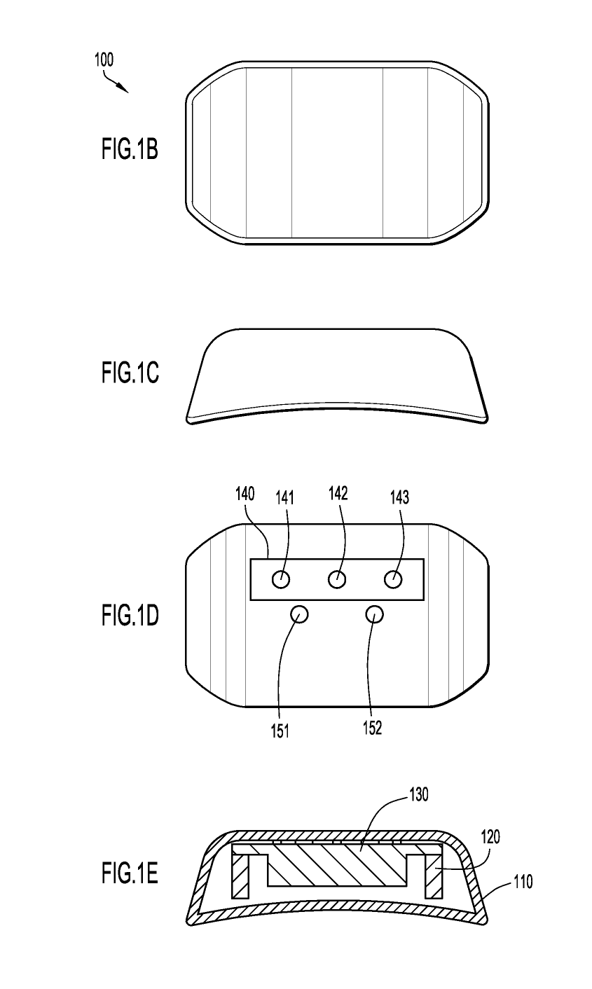

With reference now to the Figures, a helmet 102 with an attached impact detection system according to an embodiment of the present invention is illustrated in FIG. 1A. The impact detection system can attach to the external lower rear (or other location) of the helmet via, e.g., double-stick tape, such as 3M 4011 Exterior Weather-Resistant Double-Sided Tape.

Bottom, side, top, and side cross-sectional views of impact detection system 100 according to an embodiment of the present invention are illustrated in FIGS. 1B-1E respectively. Sensor enclosure 110 is essentially a box that contains circuit board 130 and a hardware force attenuation system comprising elastic material 120. The length, width, and height of the enclosure can be at least as small as 1.5″×1″×0.3″. At least one microprocessor resides on the circuit board (described below) and receives signals from one or more accelerometers. The enclosure can be rigid plastic, preferably an injection molded polycarbonate. It can be watertight, water-resistant, etc. The top and side surfaces of the enclosure can be predominantly flat. The corners and top and side edges can be rounded. The bottom outer surface can be concave to match a convex outer surface of a rounded helmet (e.g., the lower portion of the back of the helmet) and can be attached to a helmet or other article, e.g., with double-stick tape. In one embodiment, elastic material 120 disposed between the enclosure and the circuit board absorbs a percentage of the energy transferred to the sensor enclosure. A variety of materials and configurations can be used for the shock absorption system. Several example configurations of the shock absorption system are described below.

Impact detection system 100 can include a user interface to display information and provide user controls. In one embodiment of the invention, the display includes Light Emitting Diodes (LEDs) 141-143 and the user controls include buttons 151-152, visible on the top surface of the enclosure. In particular, a green LED 141, a yellow LED 142, and a red LED 143 are electrically connected to the circuit board and controlled by the microprocessor to indicate impacts and status of the system. In another embodiment, the display includes a liquid-crystal display (LCD) and/or audio speaker in place of or in addition to LEDs. A first switch-actuating button 151 and a second switch-actuating button 152 on top of the enclosure are accessible to the user. The first switch-actuating button is used once by the user the initialize the system. The second switch-actuating button can be used to reset the system. The second switch-actuating button may be configured so that a player may not easily reset the system (e.g., during a game). For example, the button may be small and recessed so that a tool (e.g., an unfolded paper clip) is required to actuate the switch via the button.

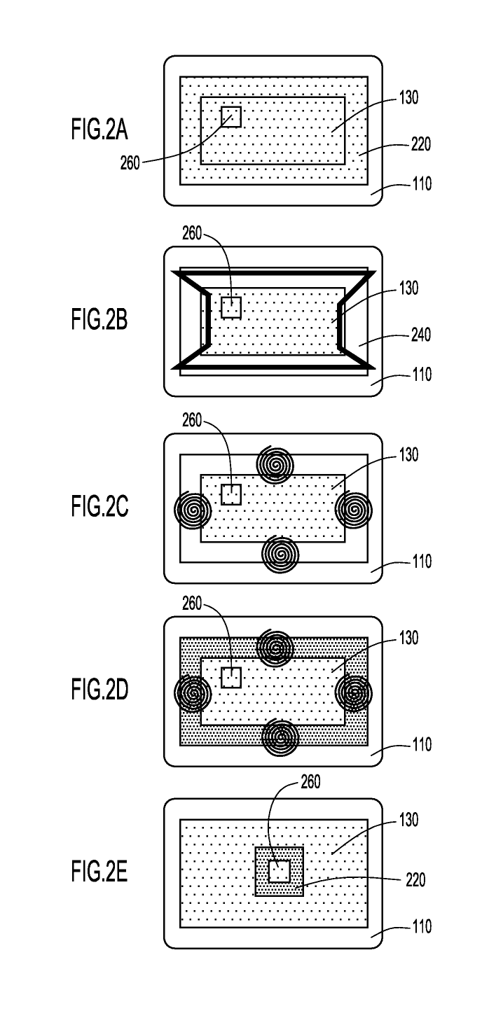

Example configurations of a shock absorption system according to an embodiment of the present invention are illustrated in FIGS. 2A-2E. The shock absorption system mechanically absorbs energy from a hit to a helmet or other article to which the sensor is affixed, and thereby scales down the impact. For example, a 100 g impact to the helmet could be scaled down to 10 g transferred to the sensors. Example configurations include shock absorbing foam rubber, a suspension system using polyurethane O-rings or rubber bands, etc.

In FIGS. 2A-2D one or more sensors 260 for detecting acceleration, location, and/or rotation (e.g., a gyroscope) are located on circuit board 130. In FIG. 2A, force absorbing material 220 (e.g., foam rubber) serves as a cushion between the circuit board and the enclosure. In FIG. 2B, an elastic material 240 (e.g., rubber band) serves as a suspension system between the circuit board and the enclosure. In FIG. 2C, springs 250 serve as a suspension system between the circuit board and the enclosure. In FIG. 2D, a force absorbing material 220 is used in conjunction with a spring suspension system.

In FIG. 2E, one or more sensors 260 are mechanically isolated from circuit board 130 and from enclosure 110 by absorbing material 220. For example, the absorbing material may be affixed onto the circuit board and the sensors affixed onto the absorbing material. Connection 270 provides a path for signals from the sensors to the microprocessor via the circuit board. Connection 270 may be, e.g., a flexible conducting wire of sufficient length to accommodate motion of the sensors relative to the circuit board.

In an embodiment of the invention, the peak acceleration of the sensor can be less than ninety percent of the peak acceleration of the enclosure, and the system can measure accelerations of the enclosure greater than 10 g.

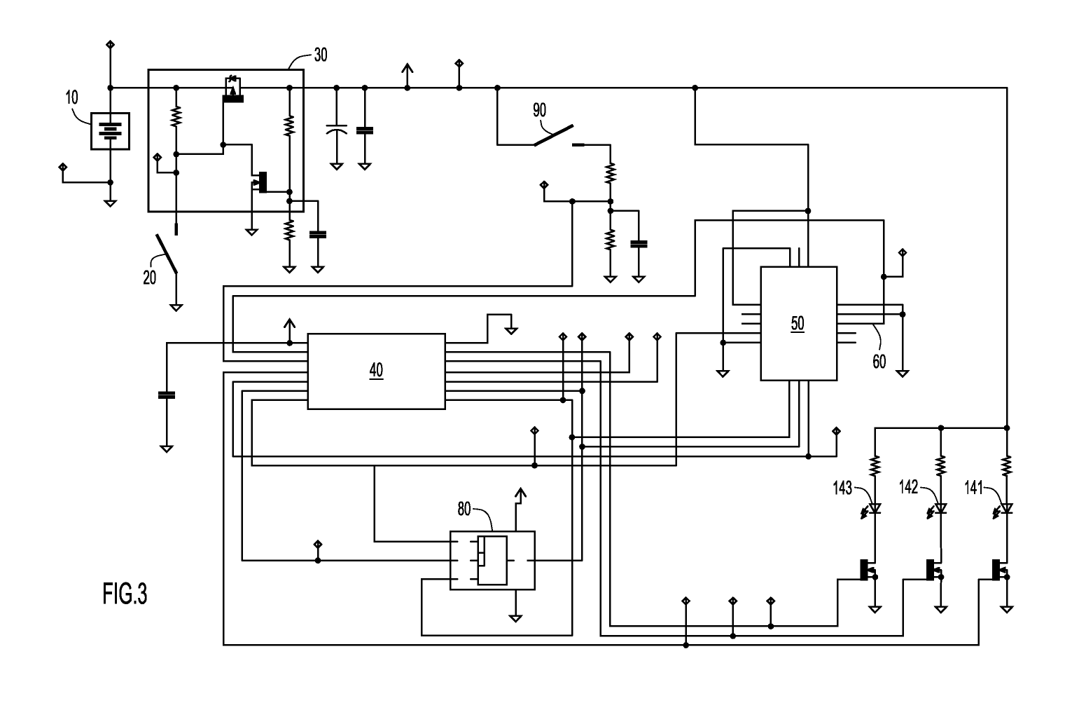

A schematic illustration of circuit board 130 according to an embodiment of the present invention is shown in FIG. 3. The circuit board connects battery 10 to first switch 20. In one embodiment of the invention, the user cannot replace the battery, and unit must be replaced at the end of the battery lifetime. For example, the battery may have a minimum lifetime of nine months and a target lifetime of one year. Once the user closes first switch 20 (e.g., via button 151), a metal oxide semiconductor field effect transistor (MOSFET) 30 is latched closed and power flows. When powered, microprocessor 40 enables an internal oscillator and begins executing instructions from internal memory. The microprocessor is connected by a serial peripheral interface (SPI) bus to accelerometer 50. Connection 60 provides an interrupt output signal from the accelerator to the microprocessor. Red, yellow, and green LEDs 141-143 are controlled by outputs from the microprocessor, which illuminates specific LEDs when certain conditions are met. The microprocessor is also connected, using the SPI bus, to external memory 80, available for storing and retrieving data. A second user switch 90 is available and can be closed via button 152.

The circuit board operates in the following manner. When battery 10 is present, the user can enable the circuit by closing first switch 20 (e.g., via button 151). MOSFET 30 latches closed and the clock of microprocessor 40 starts running, beginning execution of instructions from internal memory. The microprocessor uses the serial peripheral interface (SPI) bus to communicate with accelerometer 50. The instructions configure the microprocessor and accelerometer and then set them in low power modes. The accelerometer is configured such that if it senses acceleration above a set threshold T1, it will assert an interrupt 60 causing the microprocessor to exit low power mode and begin executing instructions to process data from the accelerometer. If the data is above a particular higher threshold T2, the data is logged and a first counter is incremented. If the data is above a yet higher threshold T3, the data is logged and a second counter is incremented.

Periodically, the microprocessor flashes the LEDs to indicate the internal state. The green LED flashes periodically to indicate the device is working. The yellow LED periodically flashes a number of times corresponding to the number of events logged in the first counter. The red light periodically flashes a number of times corresponding to the number of events logged in the second counter. In an embodiment including an LCD, the display can show the number of impacts of each type.

If the accelerometer/microprocessor does not detect acceleration above a set threshold for a set period of time, the circuit automatically enters low power mode.

External storage 80 is provided for the microprocessor to store data. Second switch 90 is provided to reset the counters and is actuated via button 152.

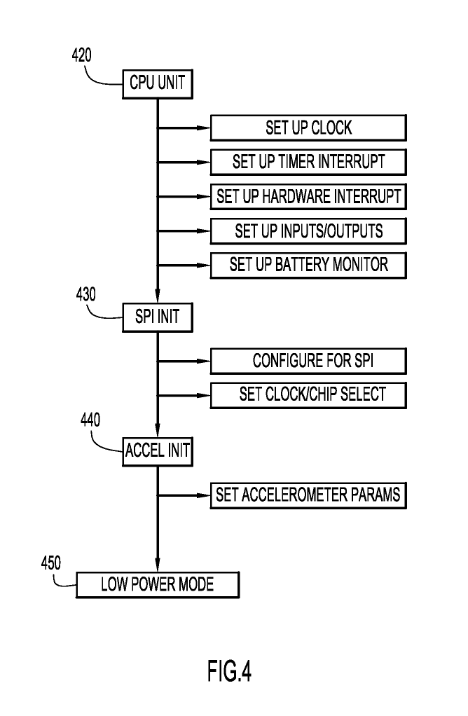

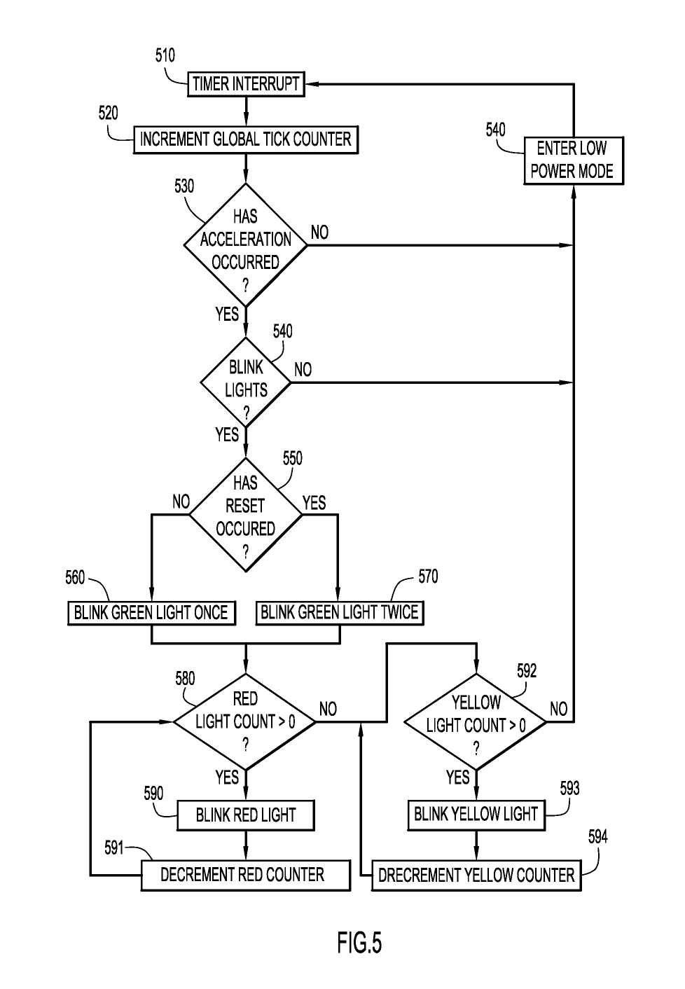

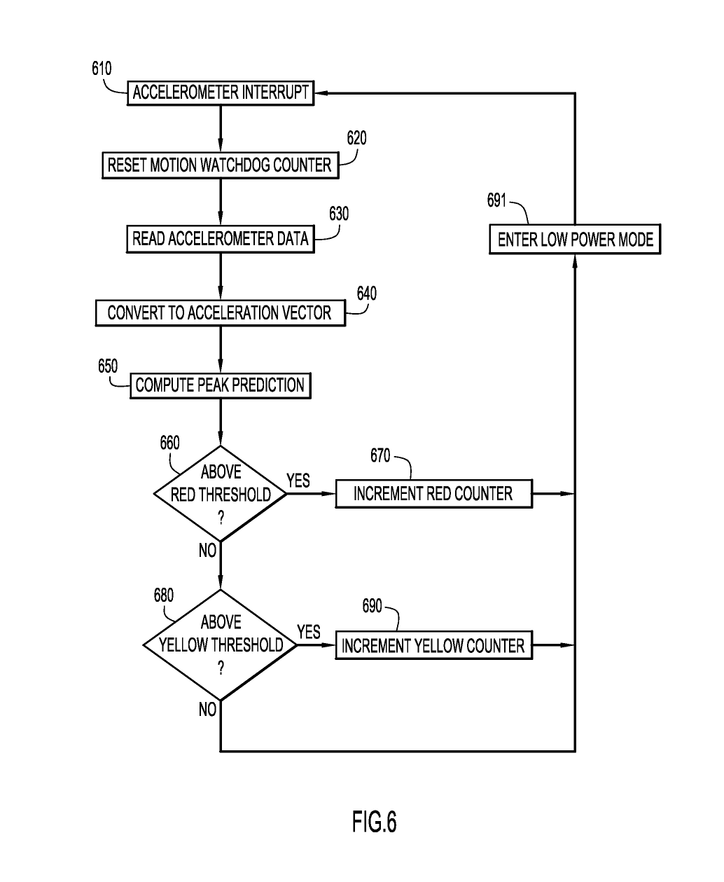

The software for the sensor assembly operates in two modes. The first mode performs a configuration that is done once, at startup. A manner of performing the configuration at startup according to an embodiment of the present invention is illustrated in FIG. 4. The CPU is initialized at step 420; the Serial Peripheral Interface (SPI) is initialized at step 430; and the Accelerometer is initialized at step 440. The device is set into low power mode, defined by the microcontroller architecture and instruction set, at step 450.

During CPU initialization 420, the software instructs the processor to set its main clock to run at 1 MHz and the auxiliary clock to be internally regulated and run at 12 kHz. A timer interrupt is set up to occur every second. A hardware interrupt is configured to read a button-actuated switch (e.g., the switch actuated by the second button to reset counts) and an output from the accelerometer. Ports and pins are configured as input and output to read the button-actuated switch and to illuminate the indicator lights when instructed.

During SPI initialization 430, the software sets up the device to use a four wire Serial Peripheral Interface bus to communicate with the accelerometer and off board memory. SPI requires that each peripheral on the bus be addressable through a chip select signal and have a clock source configured.

Accelerometer initialization 440 performs set up procedures that load parameters into the accelerometer describing the range for which it will report data, how the data will be reported, the behavior of the interrupts, the threshold at which the interrupt is triggered and the speed of data acquisition. In one embodiment, the accelerometer operates at 1 kHz and will measure up to 24 g, reporting the measurement in two eight byte reads with the most significant byte being first. The device will trigger a latching interrupt on a rising edge as long as the acceleration is greater than 3% of the range on any axis.

The last stage in the configuration mode sets the system to low power mode. This turns off all the clocks and peripherals except for the auxiliary clock running at 12 kHz. The device will return from low power mode to normal operation when an interrupt occurs. There are two types of interrupts: internally generated and externally generated.

Internally generated interrupts come from the timer once per second (or as otherwise configured at initialization). A manner of handling a timer interrupt (e.g., via processor 40) according to an embodiment of the present invention is illustrated in FIG. 5. When a timer interrupt occurs 510, a global counter measuring elapsed intervals (e.g., seconds) is incremented at step 520. At step 530, a determination is made whether or not an acceleration event caused motion of the device in the previously defined amount of time (time between timer interrupts), and therefore whether the device should be ‘awake’. If not, the device reenters low power mode. Otherwise, the device is awake, and a decision is made at step 540 whether to blink the lights. In one embodiment, the lights only blink at a predefined frequency. At step 550, a determination is made whether the device has been reset in a preceding predetermined amount of time (e.g., twelve hours). If so, the device will blink the green light at step 570 twice to indicate that it is ‘awake’, functioning, and has been reset. Otherwise, the green light will blink once at step 560, indicating that the device is functioning normally. In either case, processing proceeds to step 580, where a decision is made as to whether impacts have been sufficient to alert at the ‘Red’ level. Specifically, a determination is made as to whether a count of ‘Red’ events (i.e., impacts with acceleration greater than T3) is greater than zero. If so, the processor blinks the red light at step 590, decrements the counter at step 591, and returns to step 580 to determine if the counter is still greater than zero. In other words, the number of ‘Red’ events is indicated by blinking the red LED once for each ‘Red’ event. If the counter is not greater than zero at step 580, the processor checks and indicates the number of ‘Yellow’ events (i.e., impacts with acceleration greater than T2) in the same manner as for ‘Red’ events. A determination is made as to whether a count of ‘Yellow’ events is greater than zero at step 592. If so, the processor blinks the yellow light at step 593, decrements the counter at step 594, and returns to step 580 to determine if the counter is still greater than zero. If the counter is zero at step 592, the device returns to low power mode at step 540.

A manner of handling an acceleration event (e.g., via processor 40) according to an embodiment of the present invention is illustrated in FIG. 6. When an acceleration event occurs, an interrupt is triggered at step 610. An acceleration event resets a timer at step 620. When the timer is not reset and expires, the device enters low power mode. The software then reads the acceleration data from the accelerometer using the SPI bus at step 630. The raw data is converted to an acceleration vector at step 640. The acceleration's peak is predicted at step 650 by recording the change in acceleration over time as it rises to the maximum value measurable by the accelerometer. Then the acceleration over time is recorded as it returns from the accelerometer's maximum measurable value. These data sets are used to estimate the maximum acceleration by determining where they intersect based on linear extrapolations of the rising and falling edges with a correction factor applied for the signal shape. For example, given a maximum value to which the accelerometer is sensitive, when the processor encounters data reaching that maximum value (saturation), it can record the last ten data points before saturation and fit a first line using a least squares technique. Then when the accelerometer returns from saturation, that is, the signal is again in its measureable range, the next ten points are recorded and fit to a second line. The maximum acceleration can be estimated as the intersection of the first and second lines. The estimated value is then compared to the ‘Red’ threshold T3 at step 660, and if it is greater, a ‘Red’ counter is incremented at step 670. If the data is below the ‘Red’ threshold, it is compared to the ‘Yellow’ threshold T2 at step 680. If it is above the ‘Yellow’ and below the ‘Red’ threshold, a ‘Yellow’ counter is incremented at step 690. In all cases, the device reenters low power mode at step 691.

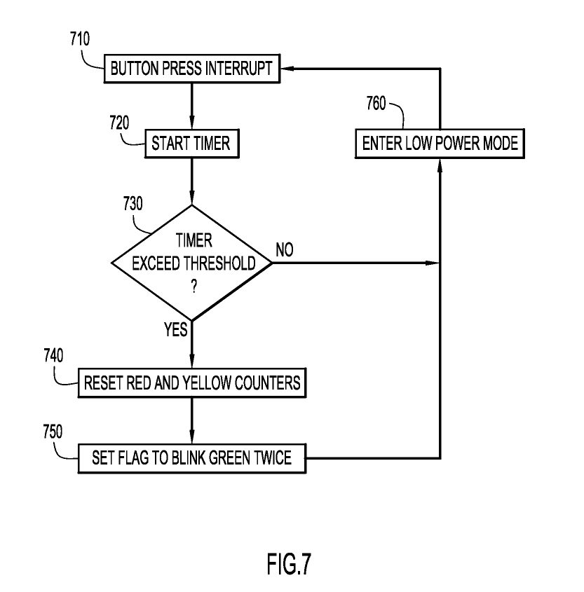

A manner of handling a user action (e.g., via processor 40) according to an embodiment of the present invention is illustrated in FIG. 7. When a button press occurs, another interrupt is dispatched at step 710. In response to this interrupt, a timer is started at step 720. At step 730, it is determined whether the interrupt has been present for a preset number of seconds. If so, all the counters are reset at step 740, and a flag is set at step 750 to indicate the green light should blink twice every cycle for the next predetermined number of hours. The device then reenters low power mode at step 760.

Alternative embodiments of the present invention use a polyvinylidene fluoride or polyvinylidene difluoride (PVDF) cantilever type piezo sensing film element to sense acceleration and impact. These films historically have been used to measure impact and vibration by measuring the voltage created when the piezo beam bends. Present invention embodiments reconstruct an initial acceleration based on measurements of the resultant vibration or ringing of the signal and the dynamics of the piezo beam.

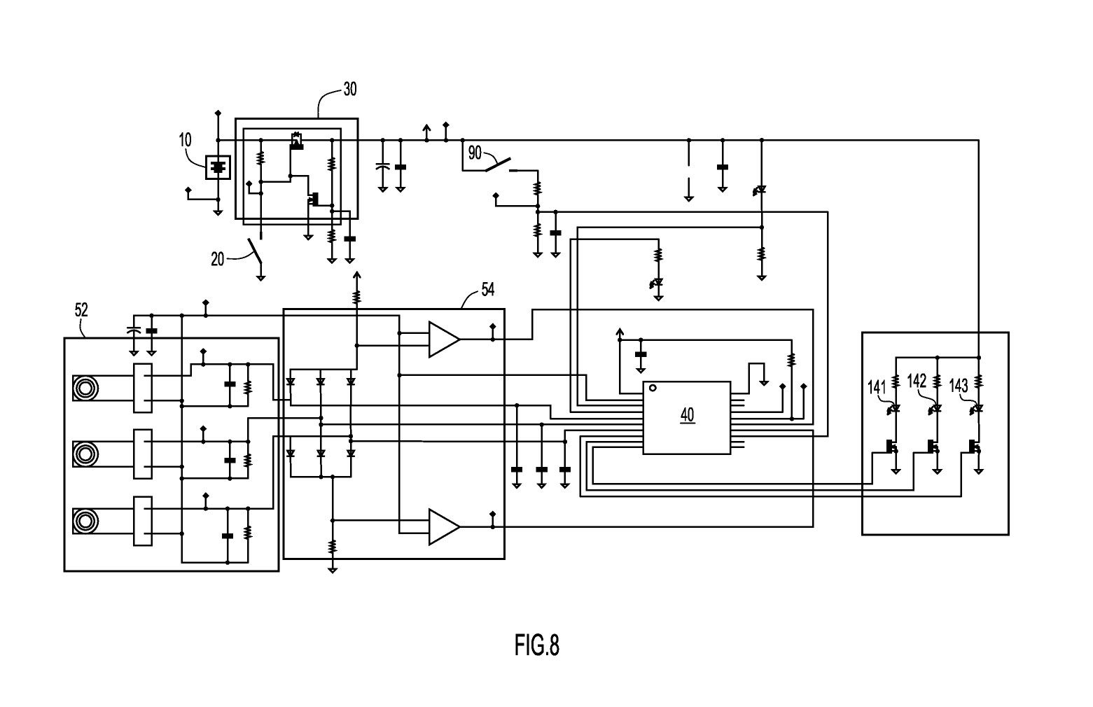

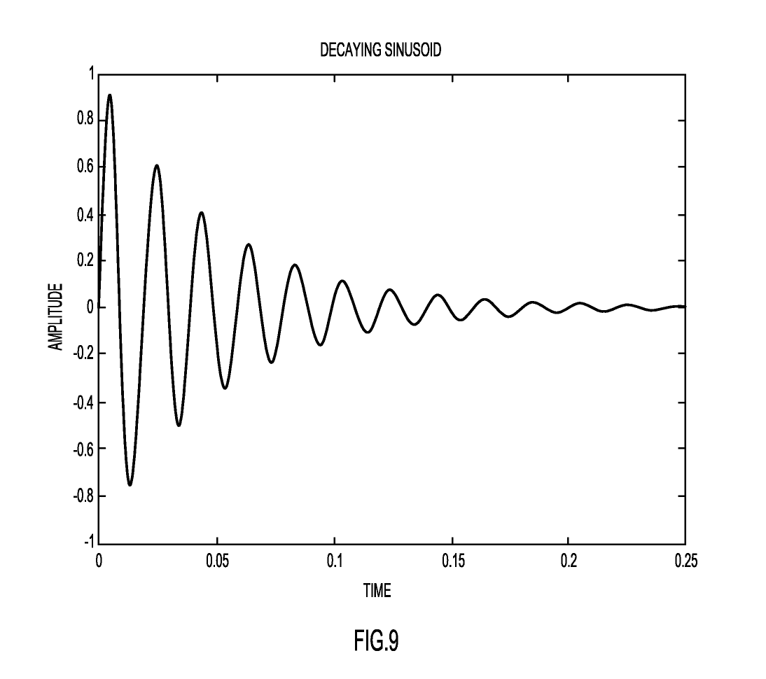

A schematic illustration of a circuit board 130 using a cantilever type piezo sensing element according to an embodiment of the present invention is shown in FIG. 8. The board includes a battery 10 connected to a switch 20. Upon the switch being pressed once by the user, a metal oxide semi conductor field effect transistor (MOSFET) 30 is latched closed and power flows. When powered, microprocessor 40 enables an internal oscillator, and begins executing instructions from internal memory. The microprocessor is connected to one or more piezo elements 52 (e.g., three elements to measure acceleration in three dimensions). By way of example, the piezo elements may include the MiniSense 100 from Measurement Specialties. These sensors are a piezo film with a mass on the end. The signal output, in response to an impact is a classic spring-mass-damper second order linear system. The output of the piezo element is a decaying sinusoid as illustrated, by way of example, in FIG. 9.

A connection extends from the microprocessor to a motion detection circuit 54 which includes inputs from piezo element(s) 52. Red, yellow and green LEDs 141-143 are controlled by outputs from the microprocessor, and are illuminated in response to the presence of certain conditions (e.g., to indicate those conditions, such as the degrees of head trauma, etc.). A second user accessible switch 90 is available for a person to signal the executing software (e.g., if LEDs 141-143 indicated a level of head trauma above a threshold and a person knew this to be false in some way, the switch may be used as a reset to erase the indication).

Once the processor has performed an initial configuration phase, motion detection circuit 54 can trigger a motion detection interrupt in response to a signal from the piezo sensor(s) resulting from an impact. The processor then receives data from the piezo sensor signal, and processes the data to determine a magnitude of the impact. For example, the processor may determine the parameters to the well-known solution to the spring-mass-damper governing differential equation:

mÿ+b\dot{y}+ky=0.

The solution is

y(t)=e^{-αt}A cos(ω_{d}t+φ)

where the damping constant α is

$$α = \frac{b}{2 m} ,$$

the damped natural frequency ω_{d} is

ω_{d}=\sqrt{ωₒ²−α²},

and the undamped frequency ω₀ is

ω₀=\sqrt{k/m}.

The constants A and φ are determined by the initial conditions.

By measuring the magnitude of the peaks and the time of the peaks, the magnitude of the initial response can be inferred by the processor using a least squares fit at step 1070. The peaks of the decaying sinusoid lie on a curve described by the following exponential equation:

y(t)=Be^{-αt.}

This equation can be expressed in linearized form as:

ln(y(t))=ln B−αt.

A least squares fit gives:

$$- α = \frac{{\sum }_{i = 1}^{n} {y}_{i} {\sum }_{i = 1}^{n} ( {t}_{i} {y}_{i} ln {y}_{i} ) - {\sum }_{i = 1}^{n} ( {t}_{i} {y}_{i} ) {\sum }_{i = 1}^{n} ( {y}_{i} ln {y}_{i} )}{{\sum }_{i = 1}^{n} {y}_{i} {\sum }_{i = 1}^{n} ( {t}_{i}^{2} {y}_{i} ) - {( {\sum }_{i = 1}^{n} {t}_{i} {y}_{i} )}^{2}}$$

$$ln B = \frac{{\sum }_{i = 1}^{n} {t}_{i}^{2} {y}_{i} {\sum }_{i = 1}^{n} ( {y}_{i} ln {y}_{i} ) - {\sum }_{i = 1}^{n} ( {t}_{i} {y}_{i} ) {\sum }_{i = 1}^{n} ( {y}_{i} ln {y}_{i} )}{{\sum }_{i = 1}^{n} {y}_{i} {\sum }_{i = 1}^{n} ( {t}_{i}^{2} {y}_{i} ) - {( {\sum }_{i = 1}^{n} {t}_{i} {y}_{i} )}^{2}}$$

where n is the number of points at which the signal is sampled and yᵢ and tᵢ are the signal height and time respectively of the ith data point.

The parameter B represents the magnitude of the impact and is mapped to acceleration using an experimentally determined calibration curve.

An alternative approach for the processor to compute the magnitude of the acceleration is to integrate the area under the absolute value of the curve of the signal curve (e.g., the curve of FIG. 9). In particular, the processor can sum absolute values of samples of the signal at regular time intervals. This sum is directly proportional to the area and the initial impact. The area determined is mapped to acceleration using and experimentally determined a calibration curve.

Yet another alternative approach to impute the magnitude of the initial impact by the processor uses knowledge of the damped natural frequency of the system. For a given initial amplitude, the sinusoid will take a corresponding amount of time and number of oscillations to fall to a given level. If a certain number of oscillations occur before the magnitude of the sinusoid oscillations below a predetermined minimum, then the initial amplitude is known to have been at least a corresponding magnitude. For example, when motion is detected by motion detection circuit 54 upon an initial impact, a timer can be started and oscillations measured (e.g., extrema, zero-crossings, or inflexion points of the decaying sinusoid can be identified and counted). If the number of oscillations exceeds a predetermined count before the timer expires and the amplitude falls below a given level, an initial acceleration meeting or exceeding to a threshold corresponding to the predetermined count occurred.

Some aspects of present invention embodiments using cantilever type piezo sensors are that low cost piezo elements can be used to quantify impulse acceleration events, while simple signal processing is used to compute impact magnitude. Further, a wide dynamic range of acceleration events can be measured, where there is zero power consumption. In fact, the sensor is a power generator.

Further embodiments of the present invention include a combination of cantilever type piezo sensors and MEMS accelerometers. The MEMS and piezo sensors can serve complementary functions. For example, the MEMS sensors can be used to measure the direction and/or duration of an impact, and to control wake and sleep modes to optimize battery life. The piezo sensors, being sensitive to rotational motion as well as linear acceleration, can used to measure the amplitude of impact.

It will be appreciated that the embodiments described above and illustrated in the drawings represent only a few of the many ways of implementing embodiments for impact detection for safety headgear.

An impact detection system may be configured as an attachment to any kind of helmet (e.g., football, lacrosse, motorsports (e.g., ETV, go-cart, mini-bike, off-road), skateboarding, scooter riding, roller skating, boxing or other martial arts, hockey, skiing, snowboarding, sledding, snowmobiling, batter's helmet, construction hard hat, etc.) or other object. The system may attach at any location of a helmet (e.g., top, front, interior surface, etc.) or other object. The sensors can alternatively be integrated into the helmet.

Any kind of acceleration sensor(s) and any kind of additional sensor(s) may be used (e.g., linear accelerometers, rotational sensors, temperature sensors, etc.). The acceleration sensors can be any technology capable of measuring acceleration (e.g., microelectromechanical system (MEMS) sensors, gyroscopes, ceramic shear accelerometers, piezo vibration sensors, etc.). For example, the system may comprise a combination of MEMS accelerometers and piezo cantilevered sensors, where the MEMS are used as a duration measurement device and the piezo sensors are used for amplitude of impact.

It is to be understood that the software of the present invention embodiments could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The present invention embodiments are not limited to the specific tasks or activities described above, but may be utilized for any type of impact or acceleration detection.

What is claimed is:

1. A system for detecting impacts comprising:
a housing containing:
a sensor for detecting acceleration of the housing and providing a signal representative of applied impacts;
a shock absorber coupling the housing and the sensor such that the sensor experiences attenuated forces relative the housing; and
a processor configured to receive data from the acceleration sensor and determine whether a magnitude of an impact exceeds a threshold.

2. The system of claim 1 comprising a plurality of sensors to detect acceleration of the housing.

3. The system of claim 1 further comprising a display for indicating whether the threshold has been exceeded.

4. The system of claim, wherein the processor is further configured to compare the magnitude of the impact to a plurality of thresholds.

5. The system of claim 3, wherein the processor is configured to indicate the impact via the display in response to determining that the impact exceeds the threshold.

6. The system of claim 3 wherein the processor is further configured to indicate via the display a cumulative number of impacts exceeding the threshold.

7. The system of claim 6, wherein the processor reduces the threshold in response to an impact.

8. The system of claim 5, further comprising means to reset a memory of impacts.

9. The system of claim 8, wherein the display indicates that the system has been reset.

10. The system of claim 5, wherein the processor is further configured to estimate a peak acceleration experienced by the accelerometer by performing a predictive analysis based on a rising edge of a signal of the accelerometer and a trailing edge the signal.

11. A system for measuring acceleration comprising:
a piezo sensor to produce a signal including a decaying sinusoid in response to an impact,
a processor configured to receive data of the signal and process the data to determine a magnitude of the impact.

12. The system of claim 11, wherein determining the magnitude of the impact comprises measuring peaks of the decaying sinusoid and performing a fit for an initial peak based on the measured peaks.

13. The system of claim 11, wherein determining the magnitude of the impact comprises integrating absolute values of the signal.
